(19) United States
(12) Patent Application Publication
(10) Pub. No.: US 2009/0038132 A1
(43) Pub. Date: Feb. 12, 2009

(54) Suspension spring removal and installation tool

(76) Inventor: Garry Wayne Zachary, Lawton, OK (US)

Correspondence Address: THE INVENTORS NETWORK, INC., 332 ACADEMY STREET, CARNEGIE, PA, 15106, US

(21) Appl. No.: 11/890,753

(22) Filed: Aug. 8, 2007

(51) Int. Cl. B23P 19/04

(52) U.S. Cl. 29/225

(57) ABSTRACT

A tool for the installation and removal of suspension springs from appliances such as washing machines includes a handle having an upper end and a base end with a spring installation and removal member pivotally interconnected to the upper end and the base end capable of receiving various extension adapters for adjusting the length of the tool to fit appliances of various makes and designs. The spring installation and removal member includes a manually graspable z-shaped hand lever portion and a spring arm that are coplanar with each other whereupon the base end of the tool, or any of the extension adapters, are fitted on the circular plate of the washing machine and the spring arm is hooked on to the upper end of the suspension springs (for top loading machines) so that pushing down on the hand lever portion facilitates suspension spring removal and installation. The tool also includes a secondary spring arm used for removing and installing suspension springs from front-loading washing machines.

### FIELD OF THE INVENTION

The present invention pertains to service, maintenance, and repair tools, and more particularly pertains to a manually operable tool for the removal and installation of suspension springs in top loading and front-loading washing machines.

### BACKGROUND OF THE INVENTION

In a modern technological society specialization is the rule, not the exception; and this also goes for the machines, equipment, and tools that power and maintain all the various aspects and functions of society from the individual level to the large scale industrial and national level.

One of the most useful and laborsaving devices is the washing machine, and while this device is generally maintenance free and long lasting, on occasion it does require servicing, repair, and maintenance. The standard washing machine—whether front loading or top loading—includes a number of major structural components that include the electronics, the spindle, the transmission, the tub, and the suspension spring or springs that control and delimit the rotation of the tub during the various washing cycles. It is often the case that the spring or springs become damaged or even break, and thus need replaced or reinstalled. The front or top cover of the washing machine must then be taken off for gaining access to the suspension spring(s). However, one must be very careful in removing the damaged or broken suspension spring or installing a new one as the springs are under a great amount of tension, and if the washing machine is a top loading type, the spring is disposed adjacent to the tub and the space between the tub and the inner wall of the container may be confined thus impeding easy access to the spring. In view of the above, a number of tools have been developed to remove springs and clamps in various fields and for various machines and devices.

For example, the Clayton patent (U.S. Pat. No. 3,800,634) discloses a hose clamp tool for forcing a self-contracting hose spring clamp to its expanded position, and for maintaining it in its expanded position for mounting and removing the clamp ring.

The Oetiker patent (U.S. Pat. No. 4,003,238) discloses a mechanism for installing band clamps that include ears, wherein the mechanism includes two pincer jaws movable relative to each other for pressing the ears of the clamp toward each other so that the band clamp can be clamped together.

The Van Dam, Jr., patent (U.S. Pat. No. 4,368,569) discloses a hose clamp tool that includes a flat plate with a rectangular opening into and through which the end portions of the hose clamp are inserted so that the plate can be rotated for exerting a camming action on the ends of the hose clamp so that the hose clamp can be manipulated for installation or removal.

The Nelson et al. patent (U.S. Pat. No. 5,125,296) discloses a pneumatic hose clamp assembly tool that includes an ergonomic, pneumatically powered hand tool having an elongated barrel and a locking jaw assembly for grasping clamps that are to be installed.

The Smith patent (U.S. Pat. No. 6,170,360 B1) discloses a tool for safely removing clip-on pre-opened hose clamps that has first and second members for fitting between and dislodging the retainer from the tangs of the hose clamp.

The Snowden patent (U.S. Pat. No. 6,199,253 B1) discloses a valve spring removal and installation tool for removing and installing valve springs on internal combustion engines, and includes a body having a handle at one end and a pair of prongs at the opposite end for engaging the valve springs.

The Donovan et al. patent (U.S. Pat. No. 6,654,997 B1) discloses a rivet removal tool and method that includes a hand held device that is clamped onto the work piece and which supports a drill and drill bit used for rivet removal.

Nonetheless, despite the ingenuity of the above devices, there remains a need for a tool for easily and quickly installing and removing suspension springs from appliances such as washing machines.

### SUMMARY OF THE INVENTION

The present invention comprehends a tool for the installation and removal of suspension springs for appliances and the like, and is especially designed for installing and removing suspension springs from various makes, models, and designs of both top loading and front loading washing machines. The tool of the present invention is differentiated from known tools in the art in so far as the tool of the present invention fits on the circular plate or housing suspension that is concentric with the transmission instead of on the base as is the case with tools presently known and used in the field of machine and appliance repair and maintenance.

Thus, the suspension spring installation and removal tool includes an elongated handle or shaft having an upper end and an opposite lower attachment or base end. Pivotally mounted at the upper end is a spring installation and removal member. The spring installation and removal member includes a z-shaped hand lever portion, an intermediate hinge or pivot portion pivotally adjoined to the upper end of the handle, and a spring arm that terminates with a spring hook having a recess or indent located at its tip. The upper end of the suspension spring is hooked onto the tip of the spring hook and the hand lever portion is manually pivoted toward the handle for extending the spring in order to facilitate its installation or removal the suspension spring. Laterally projecting from the handle is a secondary spring arm that includes a spring hole or aperture adjacent its tip. For removing or installing boot springs from front-loading washing machines, one end of the boot spring is hooked through the spring hole of the secondary spring arm with the other end of the boot spring being hooked onto the tip of the spring arm.

In the preferred embodiment of the invention, the diameter of the base end is enlarged and frustum-shaped and terminates with two spaced-apart legs that define a slot so that the base end can be fitted on the circular plate or suspension housing. The base end can be modified to receive and/or have secured thereto various embodiments of extension adapters so that the length of the tool is adjustable for use with various designs and makes of washing machines. One alternative embodiment includes a cap having a threaded stud projecting therefrom and which is screwed into an internal annular threaded bore extending into the handle at the base end thereof. A second embodiment of the extension adapter for lengthening the tool includes an extension adapter having a tongue that mates with the slot at the base end of the handle and two spaced-apart prongs that define a receiving channel for fitting onto the circular plate. A third alternative embodiment for the base end includes the base end having external threads that engage the internal annular threaded bore of a cylindrical adapter. This cylindrical adapter also includes an end portion having a slightly larger diameter with the end portion including a transverse groove for seating on the circular plate. A fourth alternative embodiment for the base end of the handle includes an extension member rotatably secured to the base end by a rivet or brad. The extension member includes two channels disposed at 90 degrees to each other with one channel being deeper than the other. A fifth alternative embodiment for an extension adapter includes the base end of the handle having the same diameter as the entire handle and not flared or frustum-shaped for receiving or having pressed thereon an extension adapter having an internal cylindrical slot wherein the base end of the handle is pressed into the cylindrical slot. This extension adapter includes two spaced-apart furcations that define a channel for fitting the extension adapter on the circular plate. This extension adapter is rotatable on the base end for achieving proper alignment of the tool relative to the suspension spring.

The tool of the present invention includes at least two embodiments for pivotally interconnecting the spring installation and removal member to the upper end of the handle. In addition, the tool can include a locking mechanism for locking the spring installation and removal member in position after it has been attached to the circular plate or housing suspension and the suspension or boot spring thereby allowing the individual to free one or both of his or her hands for other things while maintaining the position of the tool relative to the suspension spring. A further modification for the base end of the tool includes the base end having integrally formed thereon an end that resembles three spaced-apart fingers that define gaps between the fingers whereupon the fingers are slipped onto the circular plate with the configuration and spacing of the fingers maintaining the position and alignment of the tool with respect to the suspension or boot spring. It is an objective of the present invention to provide a tool for the installation and removal of suspension springs in appliances that is easy to use on both top loading and front-loading appliances such as top loading and front-loading washing machines.

It is another objective of the present invention to provide a tool for the installation and removal of suspension and boot springs in appliances that doesn't damage or stretch out of shape the springs during such installation or removal.

It is yet another objective of the present invention to provide a tool for the installation and removal of suspension springs in appliances that is a dual purpose device in so far as the tool is useful for installing and removing various other types of springs.

It is still yet another objective of the present invention to provide a tool for the installation and removal of suspension springs that saves time in such installation and removal.

It is still yet a further objective of the present invention to provide a tool for the installation and removal of suspension springs that can be manufactured from hard, heavy durable plastic or polished or chrome metal materials.

Another objective of the present invention is to provide a tool for the installation and removal of suspension springs that fits on the circular plates or housing suspensions of various types and designs of appliances such as washing machines.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the preferred embodiment of the tool for the installation and removal of springs, such as suspension and boot springs, of the present invention;

FIG. 2 is a front elevational view of the tool for the installation and removal of suspension springs of the present invention illustrating the disposition of the tool on a top loading washing machine for installing or removing the suspension spring;

FIG. 3 is a front elevational view of the tool for the installation and removal of suspension springs of the present invention illustrating the pivoting of the spring installation and removal member for removing the suspension spring from a top loading washing machine;

FIG. 4 is a top plan view of the tool for the installation and removal of boot springs of the present invention illustrating the use of the tool with a front-loading washing machine;

FIG. 5 is a top plan view of the tool for the installation and removal of boot springs of the present invention illustrating the pivoting of the spring installation and removal member for removing the boot spring from the front loading washing machine;

FIG. 6 is a partially sectioned side elevational view of the tool for the installation and removal of suspension and boot springs of the present invention illustrating an alternative embodiment for an extension adapter for the base or mounting end of the handle of the tool;

FIG. 7 is a partially sectioned side elevational view of the tool for the installation and removal of suspension and boot springs of the present invention illustrating the alternative embodiment for the extension adapter for the base or mounting end of the handle of the tool first shown in FIG. 6;

FIG. 8 is an enlarged perspective view of the base end of the tool for the installation and removal of suspension and boot springs of the present invention first shown in FIG. 1 illustrating the use of a second preferred embodiment for an extension adapter that is removably securable to the base end of the handle of the tool;

FIG. 9 is a perspective view of the tool for the installation and removal of suspension and boot springs of the present invention illustrating the second preferred embodiment of the extension adapter first shown in FIG. 8 and which is removably securable to the base end of the handle of the tool;

FIG. 10 is a side elevational view in partial section of the tool for the installation and removal of suspension and boot springs illustrating a third preferred embodiment for an extension adapter that is removably securable to the base end of the handle of the tool;

FIG. 11 is a side elevational view of the tool for the installation and removal of suspension and boot springs of the present invention illustrating a fourth preferred embodiment for an extension adapter that is rotatably secured to the base end of the handle of the tool;

FIG. 12 is an enlarged sectioned elevational view of the tool for the installation and removal of suspension and boot springs illustrating the extension adapter first shown in FIG. 11 and showing the extension adapter rotated 90 degrees to disclose a second and smaller channel intersecting the channel shown in FIG. 11;

FIG. 13 is an elevational view of the tool for the installation and removal of suspension and boot springs of the present invention illustrating a fourth preferred embodiment for an extension adapter that is removably attachable to the base end of the handle of the tool;

FIG. 14 is an elevational view of the tool for the installation and removal of suspension and boot springs of the present invention illustrating the extension adapter first shown in FIG. 13 fully seated on and attached to the base end of the handle of the tool;

FIG. 15 is a side elevational view of the tool for the installation and removal of suspension and boot springs of the present invention illustrating an alternative embodiment of the pivotal means that interconnects the upper end of the handle to the spring installation and removal member;

FIG. 16 is a side elevational view of the tool for the installation and removal of suspension and boot springs of the present invention illustrating an extension adapter for the pivotal means first shown in FIG. 15 that interconnects the spring installation and removal member to the pivoting member;

FIG. 17 is a side elevational view of the tool for the installation and removal of suspension and boot springs of the present invention illustrating an alternative embodiment for the hand lever portion and spring arm of the spring installation and removal member whereby the hand lever portion and the spring arm are pivotally interconnected to each other;

FIG. 18 is a side elevational view of the tool for the installation and removal of suspension and boot springs illustrating the alternative embodiment for the spring installation and removal member first shown in FIG. 17 wherein the hand lever portion and the spring arm are pivoted downward adjacent and parallel to the upper end of the handle of the tool;

FIG. 19 is a perspective view of the tool for the installation and removal of suspension and boot springs of the present invention illustrating a locking and releasing mechanism incorporated into the upper end of the handle of the tool and the intermediate portion of the spring installation and removal member;

FIG. 20 is a perspective view of the tool for the installation and removal of suspension and boot springs of the present invention illustrating a catch mounted adjacent the base end of the handle for holding and maintaining the spring installation and removal member in position so that the individual can have one or both hands free;

FIG. 21 is a perspective view of the tool for the installation and removal of suspension and boot springs of the present invention illustrating a second preferred embodiment for a catch for holding the spring installation and removal member in position so that the individual can have one or both hands free;

FIG. 22 is a perspective view of the tool for the installation and removal of suspension and boot springs of the present invention illustrating an alternative embodiment for the base end of the handle of the tool;

FIG. 23 is a perspective view of the tool for the installation and removal of suspension and boot springs of the present invention illustrating the alternative embodiment first shown in FIG. 22 from a different viewpoint or angle; and

FIG. 24 is a perspective view of the tool for the installation and removal of suspensions and boot springs of the present invention illustrating the alternative embodiment for the base end of the handle of the tool first shown in FIG. 22 from yet another viewpoint or angle.

### DETAILED DESCRIPTION OF THE PREFERRED EMBODIMENT

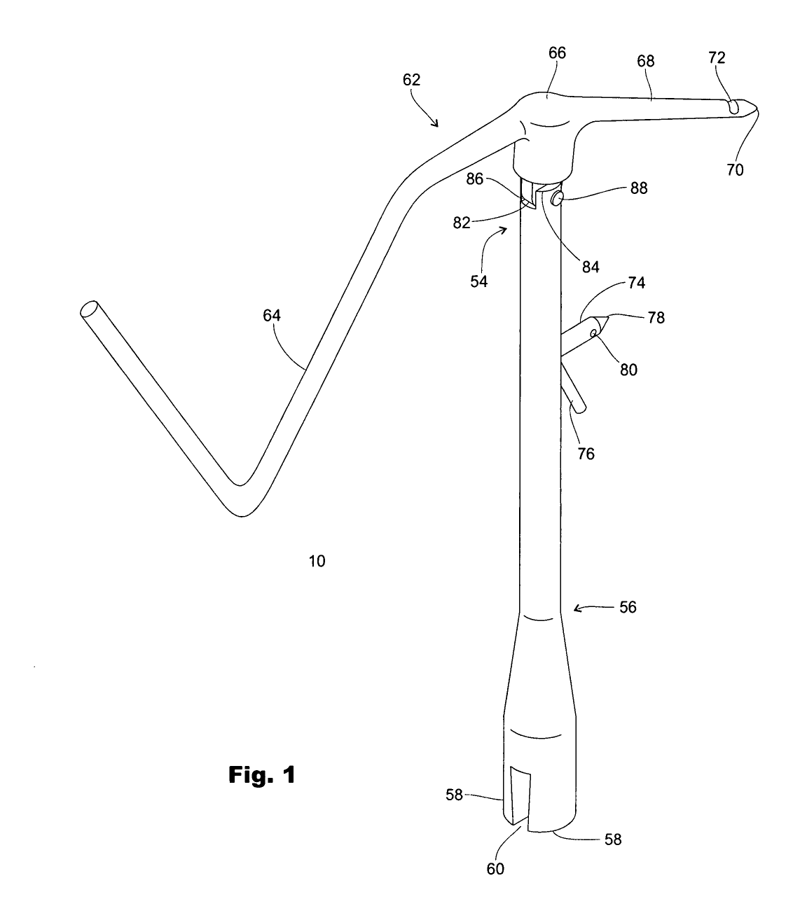

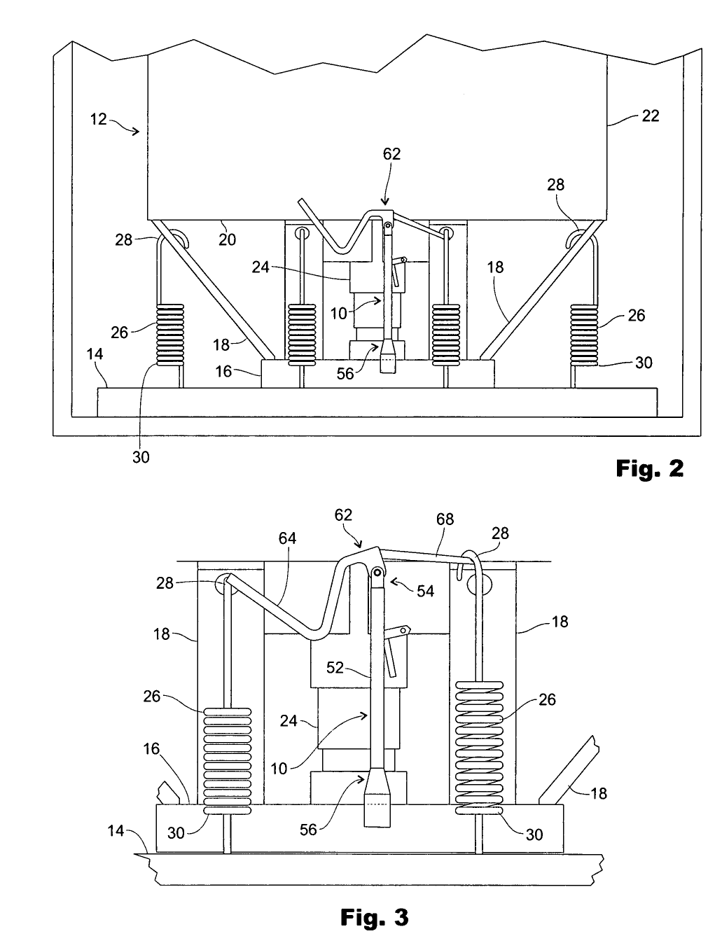

Illustrated in FIGS. 1-24 is a tool 10 for the installation and removal of suspension springs that are primary structural components of various types of machines and devices such as household appliances, with the tool 10 of the present invention being especially suited for removing suspension springs from numerous makes, models, and designs of both top loading and front loading washing machines. Thus, FIGS. 2 and 3 illustrate a representative top loading washing machine 12. The top loading machine 12 includes a base 14, a circular (generally plastic) plate or housing suspension 16 that sits upon the base 14, and a plurality of radially arranged, upwardly angled struts 18 that attach to the underside or bottom 20 of the tub 22 and support the tub 22 of the machine 12. Extending upwardly from the base 14 and circular plate 16, and concentric thereto, is a transmission/motor 24 that actuates the shaking and tumbling motion of the tub 22 as part of the process of washing clothes. A plurality of suspension springs 26, also radially arranged about the bottom 20 of the tub 22, have their upper ends 28 hooked onto the struts 18 with the lower ends 30 of the springs 26 connected to the base 14. The springs 26 delimit and restrain the tumbling or shaking motion or action of the tub 22.

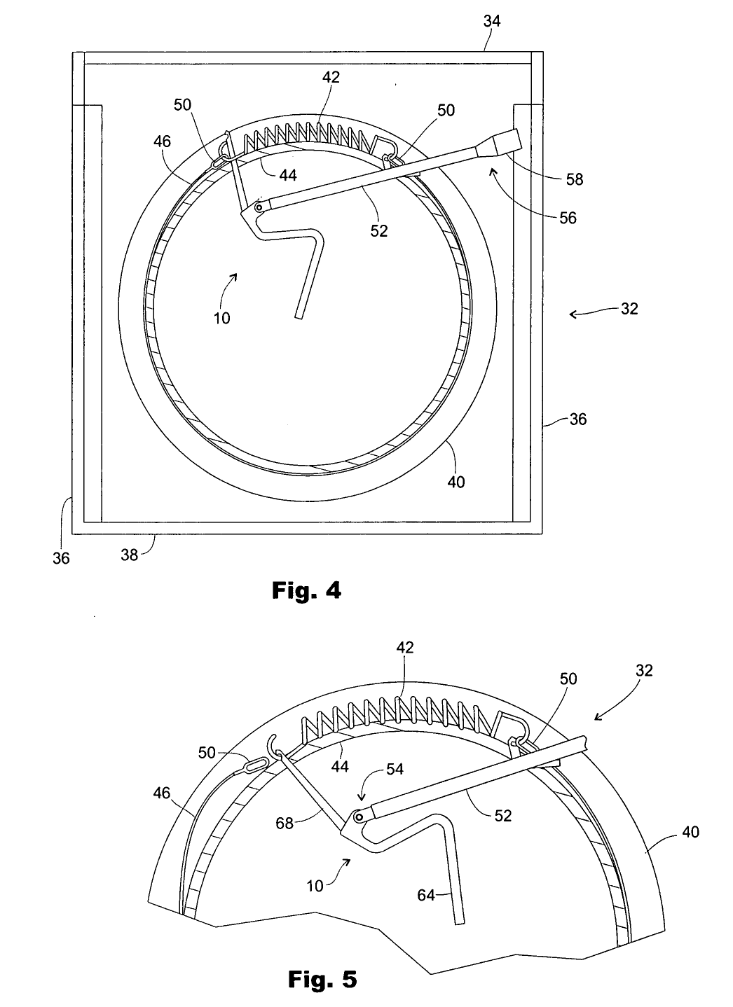

FIGS. 4 and 5 illustrate a representative front-loading washing machine 32 (for clarity the front door has not been shown). The front-loading washing machine 32 includes a top wall 34, opposed sidewalls 36, and a bottom floor or surface 38. A tub 40 is rotatably mounted within the machine 32, and a boot spring 42 extends across a portion of the upper cylindrical surface 44 of the tub 40. A strap 46 is wrapped around the tub 40 and the ends of the strap 46 include loops 48 so that one hook end 50 of the spring 42 is attachable to one loop 48 of the strap 46 and the other hook end 50 of the spring 42 is attachable to the other loop 48 of the strap 46. The rotation of the tub 40 is constrained by the strap 46 and boot spring 42 continuously expanding and contracting concurrent with the mechanically powered rotation of the tub 40 for maintaining a controlled and continuous rotational motion of the tub 40 during the various machine washing cycles. It should be noted that hereinafter reference to a single suspension or boot spring 26 or 42 denotes and incorporates by implication reference to a plurality of suspension or boot springs 26 and 42.

Illustrated in FIGS. 1-5, 8, 20, and 21 is the preferred embodiment of the invention showing the primary structural elements and features. The tool 10 for the installation and removal of a suspension spring(s) (at least one boot spring 42 for front loading machines 32 and a plurality of suspension springs 26 for top loading machines 12) includes a cylindrical elongated shaft or handle 52 having an upper end 54 and an opposite lower base or attachment end 56. The diameter adjacent the base end 56 is enlarged and is frustum-shaped thereby forming two spaced-apart legs 58 that define a central stabilization slot 60. The slot 60 is in axial alignment with the longitudinal axis of the handle 52. The slot 60 is adapted to slide onto and over the edge of the circular plate 16, as shown in FIGS. 2 and 3, for mounting the tool 10 thereon. In addition, the slot 60 is configured to accommodate one embodiment for an extension adapter as will be hereinafter further explained.

As shown in FIGS. 1-6, 10-15, and 19-21, located at the upper end 54 of the tool 10 is a pivotal or hinged interconnection means that pivotally interconnects a spring installation and removal member 62 to the upper end 54 of the tool 10. In the preferred embodiment the spring installation and removal member 62 is an integral or unitary piece that includes a generally z-shaped hand lever portion 64, an intermediate hinge or pivot portion or body 66, and a spring arm 68. The intermediate portion 66 contains the elements and is the area that is pivotally interconnected to the upper end 54 of the handle 52. The spring arm 68 terminates with a pointed tip 70, and just before the tip 70 is a recess or indent 72 that hooks onto the upper ends 28 of the suspension springs 26 as shown in FIGS. 2 and 3. The hand lever portion 64 and the spring arm 68 are located in the same plane so that when the hand lever portion 64 is manually pivoted downward toward the handle 52, the spring arm 68 concomitantly pivots upward to initiate suspension spring removal or installation.

As shown in FIGS. 1-6, 10, 20, and 21, a secondary spring arm 74 laterally projects from the handle 52. The secondary spring arm 74 is located in the same plane as the spring arm 68 and can include a laterally extending balance member 76, and the secondary spring arm 74 terminates with a pointed tip 78 having a spring hole or aperture 80 adjacent the tip 78. One hook end 50 of the boot spring 42 for the front loading washing machine 32, as shown in FIGS. 4 and 5, is hooked through the spring hole 80 of the secondary spring arm 74 as will be more fully explained hereinafter.

The tool 10 of the present invention includes several pivotal or hingable interconnection means for pivotally interconnecting the spring installation and removal member 62 to the upper end 54. Thus, a first preferred embodiment for the pivotal interconnection means includes the intermediate portion 66 having a downwardly projecting member 82 that is axially aligned with the handle 52. A pair of spaced-apart flanges 84 that define a pivot slot 86 therebetween further defines the upper end 54 of the handle 10. The downwardly projecting portion 82 fits into the pivot slot 86 with sufficient clearance and a pivot pin 88 is inserted through the flanges 84 and the downwardly projecting portion 82 so that the spring member 62 can pivot on the flanges 84 of the upper end 54 of the handle 52. In the first preferred embodiment the intermediate portion 66 has a larger diameter than the handle 52.

Illustrated in FIGS. 2-6 and 10 is a second preferred embodiment for the pivotal or hingable interconnection means. In this embodiment the upper end 54 terminates with a flat surface 90, and extending upwardly therefrom, and coaxial with the handle 52, are two spaced-apart ears 92. The intermediate portion 66 is reduced in size and diameter to fit between the ears 92, and a pivot pin 94 is inserted through the ears 92 and the intermediate portion 66 so that the spring member 62 can pivot on the ears 92 for installing and removing suspension and boot springs 26 and 42.

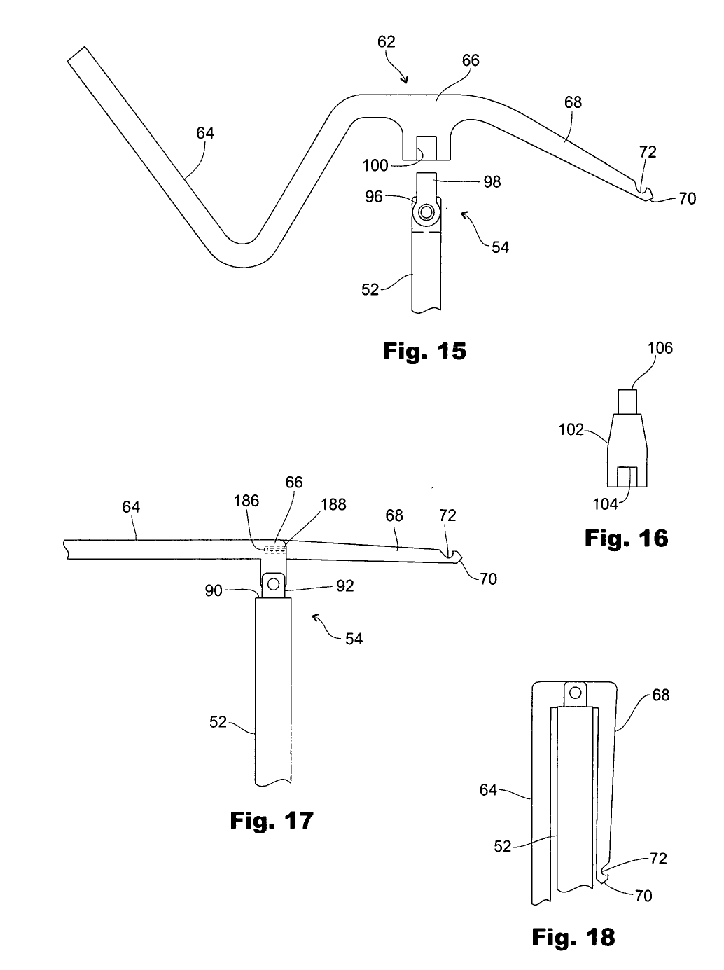

FIGS. 15 and 16 illustrate another—third—preferred embodiment for the pivotal interconnection means for the present invention. A tab 96 is pivotally mounted to the upper end 54 of the handle 52 with the projecting portion 98 of the tab 96 being square-shaped. The intermediate portion 66 for the spring member 62 includes a square-shaped aperture 100 that is pressed onto the projecting portion 98 of the tab 96 for interconnecting the spring installation and removal member 62 to the handle 52. FIG. 16 illustrates an extension member 102 that increases the overall length of the tool 10 so that the tool 10 can be adapted for various makes and models of washing machines. Extension member 102 includes a square-shaped recess 104 for fitting on the projecting portion 98 of the tab 96 and a square-shaped nubbin 106 that is inserted into the square-shaped aperture 100 formed in the intermediate portion 66 of the spring installation and removal member 62 thereby pivotally interconnecting the spring installation and removal member 62 to the upper end 54 of the handle 52 and increasing the length of tool 10.

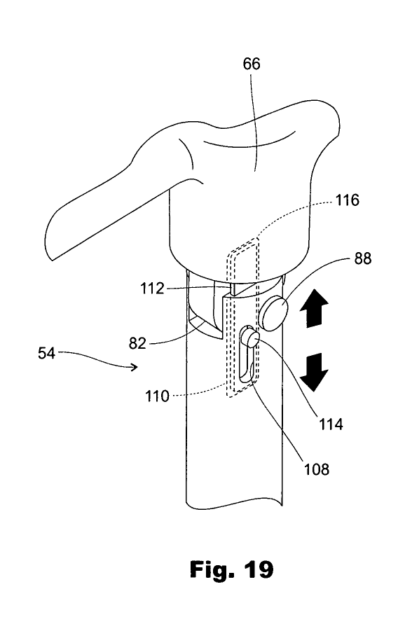

FIG. 19 illustrates a locking mechanism for selectively locking in position the tool 10 after it has been secured to the suspension or boot spring(s) 26 or 42 so that the individual can free one or both of his or her hands for other purposes assured that the tool 10 will remain in position. The locking mechanism includes a locking slot 108 formed on one of the flanges 84 and a rectangular-shaped recess 110 formed on the inside flat surface of that flange 84. Disposed within the locking slot 108 and the rectangular-shaped recess 110 for reciprocable slidable movement therein is a locking plate 112. Externally projecting through the locking slot 108 is a manually operable button 114 with the button 114 being integrally formed to the locking plate 112. A rectangular-shaped groove 116 is formed within the intermediate portion 66 and extends up into the intermediate portion 66. The groove 116 is aligned with the rectangular-shaped recess 110 formed on the inside surface of the flange 84 and is configured to receive the locking plate 112. Thus, when the button 114 is pushed down the locking plate 112 also simultaneously moves downward thereby allowing for the free unimpeded pivotal motion of the spring installation and removal member 62 on the upper end 54 of the handle 52. When the individual desires to have his or her hands free, then after the tool 10 is secured in position to the washing machine 12 or 32 and suspension or boot spring(s) 26 and 42, the tool 10 is locked in position by sliding the button 114 upward thereby causing the locking plate 112 to slide into the groove 116 within the intermediate portion 66. Once the locking plate 112 enters the groove 116 the spring installation and removal member 62 is prevented from any further pivotal motion until the locking plate 112 is slidably disengaged from the groove 116 extending into the intermediate portion 66.

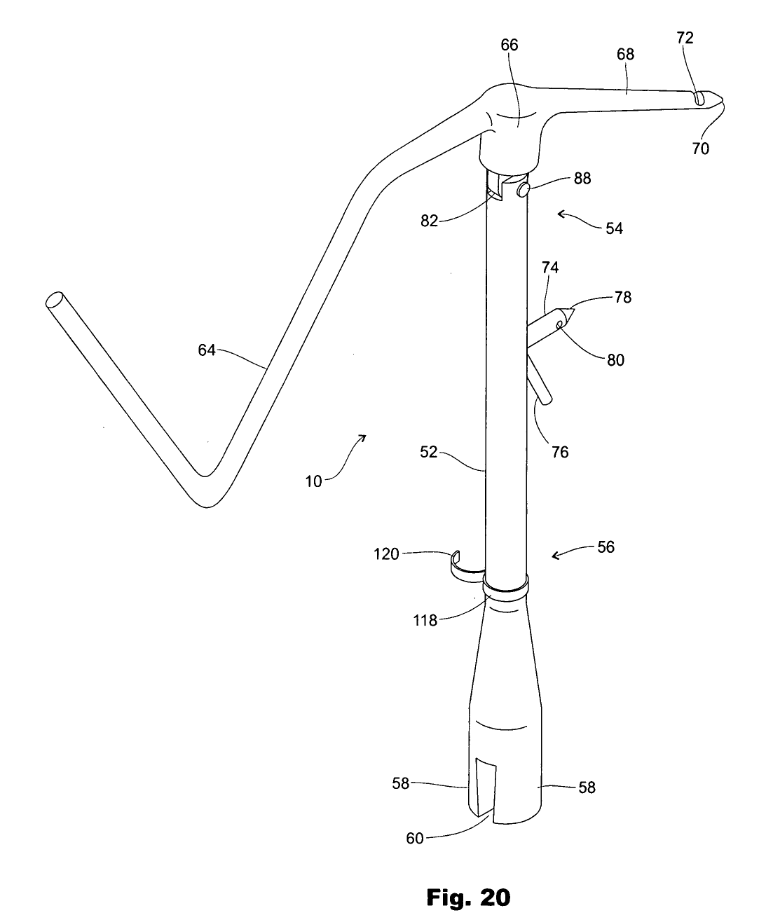

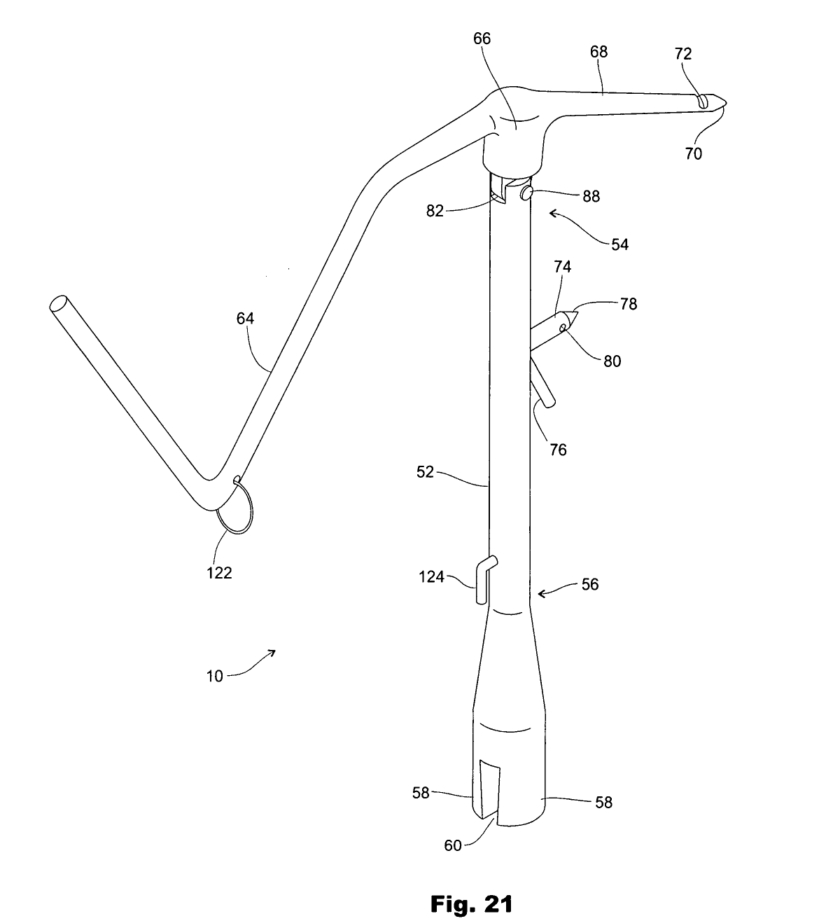

FIGS. 20 and 21 illustrate embodiments for holding the hand lever portion 64 in position after it has been pivoted during the process of installing and removing suspension or boot spring(s) 26 and 42 as specifically shown in FIGS. 3 and 5. The catch or holding means shown in FIGS. 20 and 21 allows the individual to have his or her hands free to, for example, examine other parts of the washing machine 12 or 32 or to make other adjustments to the belt, etc., without worry that the tool 10 will slip off the suspension or boot spring(s) 26 or 42. Thus, shown in FIG. 20 is a catch 118 mounted to the base end 56 adjacent the frustum-shaped portion. The catch 118 includes a semi-circular portion 120 that laterally extends outward from the axis of the handle 52. Thus, pivoting of the hand lever portion 64 toward the handle 52 (as part of the process of installing or removing the springs 26 or 42) brings the hand lever portion 64 adjacent to the semi-circular portion 120 allowing the hand lever portion 64 to be hooked onto the semi-circular portion 120 of the catch 118 maintaining the pivotal position of the tool 10.

FIG. 21 illustrates a second embodiment for the catch or holding means. In FIG. 21 a loop or ring 122 is pivotally attached to the crook or elbow of the hand lever portion 64 and a right-angled elbow 124 projects outwardly from the handle 52 adjacent the base end 56 thereof. When the hand lever portion 64 of the spring installation and removal member 62 is pivoted toward the handle 52 the ring 122 is brought adjacent to the right-angled elbow 126 and then hooked onto the elbow 124 thereby maintaining the pivotal position of the tool 10. It is assumed with regard to the holding means of FIGS. 20 and 21 that the tool 10 has already been positioned on the washing machine 12 or 32 and hooked onto the suspension spring(s) 26 or 42 prior to the pivoting of the hand lever portion 64 for hooking onto the semi-circular portion 120 or the right-angled elbow 124.

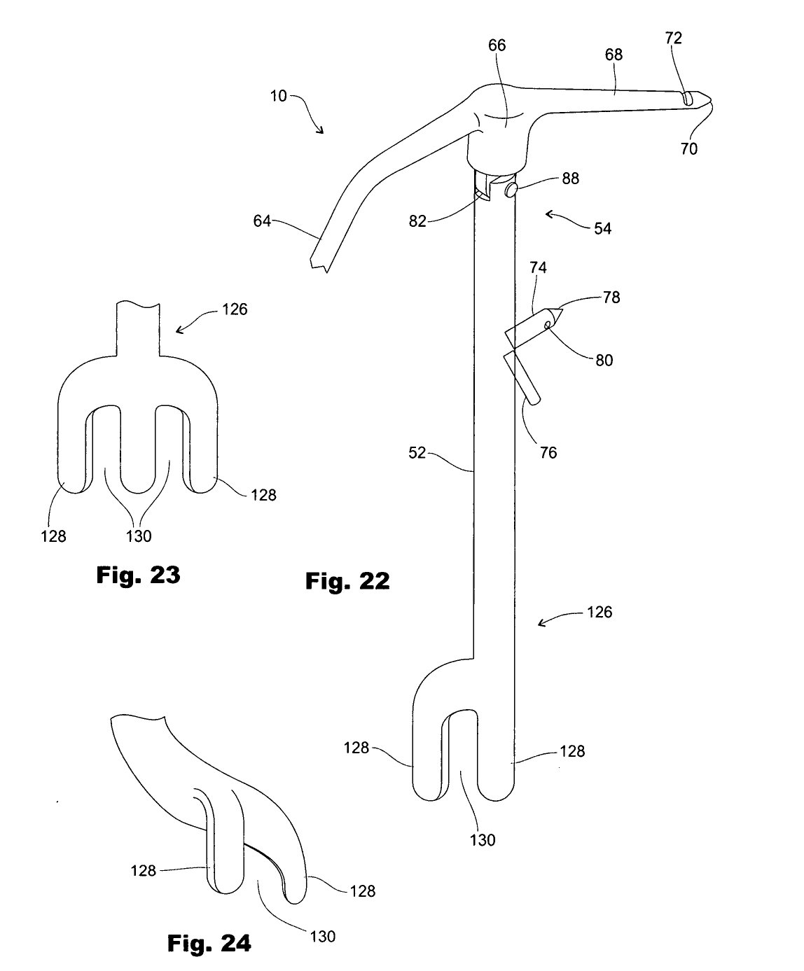

FIGS. 22-24 illustrate a modification for the attachment or base end 56 of the handle 52 in the configuration of an integrally formed base end 126 having a plurality of fingers 128 spaced from each other and defining gaps or slots 130 between the fingers 128. In this modification the base end 126 includes three fingers 128 that define at least two gaps or slots 130. The spaced-apart fingers 128 allow securement of the base end 126 of the tool 10 to non-standard makes, models and designs of washing machines. FIGS. 22-24 show the orientation of the fingers 128 from different views or angles. When using this embodiment of the tool 10 the individual is able to orient the fingers 128 of the base 126 to accommodate and fit on circular plates or housing suspensions 16 of varying heights and widths.

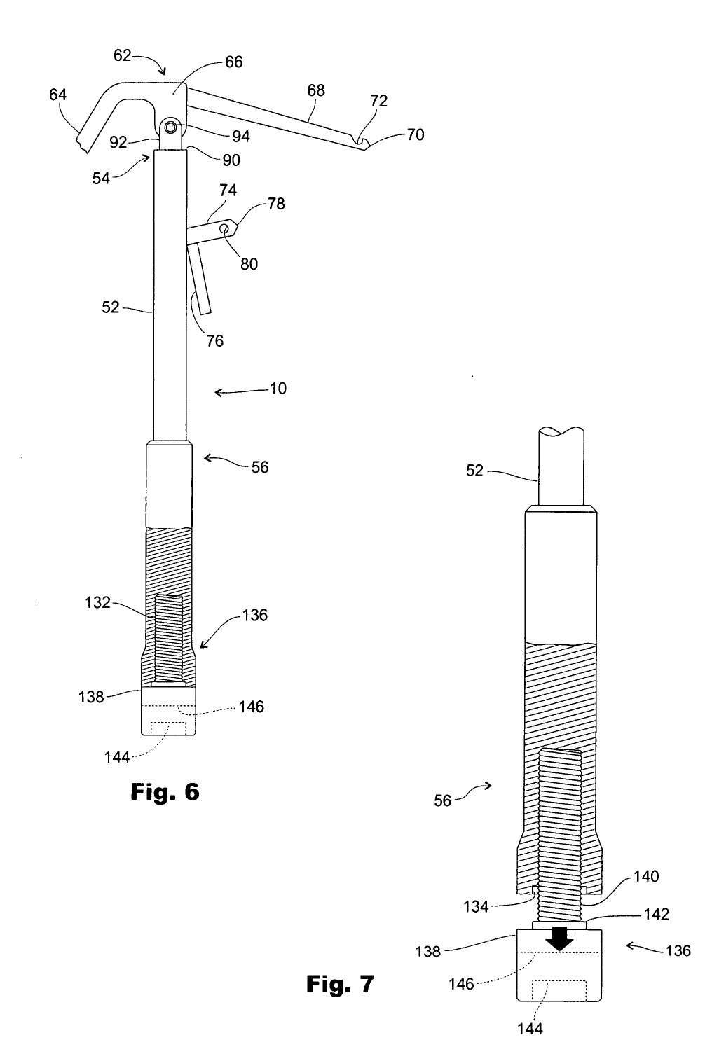

FIGS. 6 and 7, 8 and 9, 10, 11 and 12, and 13 and 14, illustrate various embodiments of extension adapter means all of which allow the individual to vary or adjust the length of the tool 10 to fit variously-sized models, makes, and designs of washing machines. The extension adapter means generally require some modification to the base end 56 of the handle 52 of the tool 10 as will be hereinafter described.

Thus, illustrated in FIGS. 6 and 7 is a first preferred alternative embodiment of the extension adapter means of the present invention. The base end 56 of the handle 52 includes an internal annular threaded bore 132 that extends into the handle 52 from the flat end surface of the base end 56. The entrance opening 134 of the bore 132 is stepped. An extension adapter 136 including a cap 138 and an integrally formed threaded stud 140 is adapted for adjustable longitudinal rotatable insertion into the internal annular threaded bore 132 of the handle 52. A circular flange 142 that adjoins the cap 138 to the threaded stud 140 seats within the stepped entrance opening 134 when the extension adapter 136 is completely inserted into the handle 52. In order to facilitate the adjustable securement of the extension adapter 136 into the handle 52 the cap 138 includes an externally opening recess 144 for receiving a socket and a slot 146 shaped to accommodate a screwdriver tip (flat head or Phillips head). Thus, the individual can use a socket or a screwdriver to insert and then adjust the depth of insertion of the extension adapter 136 into the threaded bore 132 formed in the handle 52.

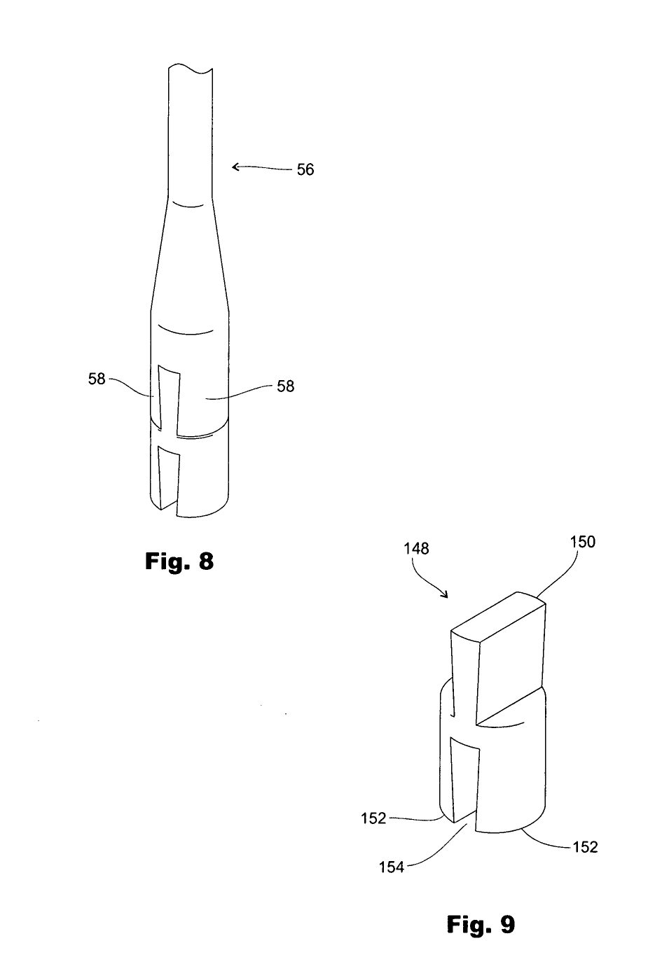

FIGS. 8 and 9 illustrate a second preferred embodiment for the extension adapter means. The attachment or base end 56 doesn't need to be modified for this embodiment. Instead, the extension adapter means shown in FIGS. 8 and 9 includes an extension adapter 148 having a flared projecting tongue 150 integrally formed to two spaced-apart prongs 152 having a generally semi-circular configuration. The spaced-apart prongs 152 further define a receiving slot, channel, or groove 154. The flared projecting tongue 150 is removably insertable into the stabilization slot 60 at the base end 56 of the handle 52 of FIGS. 1, 20, and 21, and the receiving slot 154 is slipped or placed on the circular plate 16 providing for the lengthening of the tool 10 to accommodate variously-sized models, makes, or designs of washing machines.

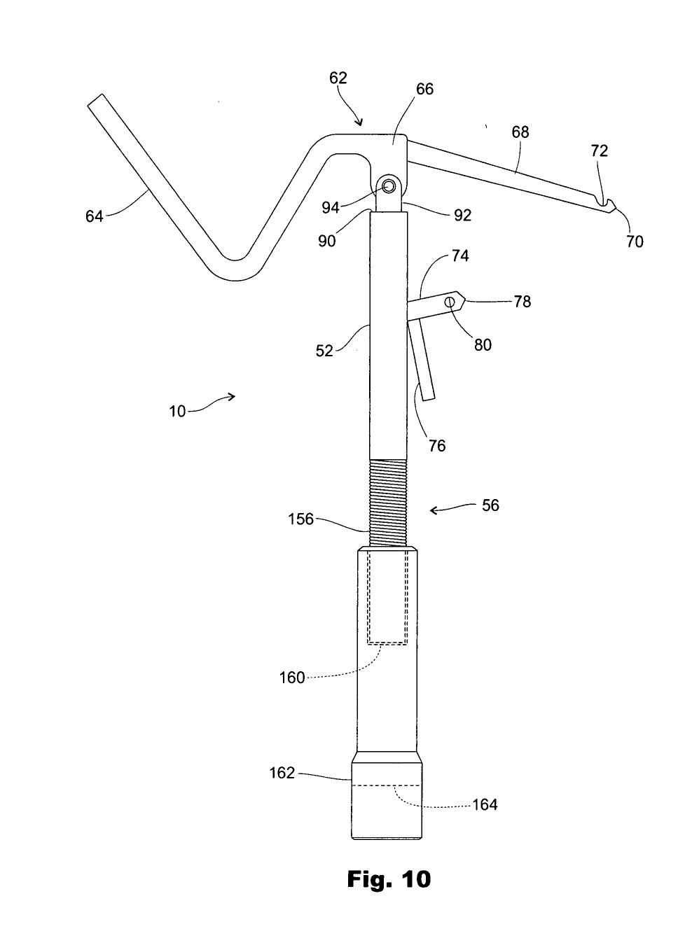

FIG. 10 illustrates a third preferred embodiment for the extension adapter means of the present invention. In FIG. 10 the base end 56 of the tool 10 has been modified to include an externally threaded cylindrical portion 156. In addition, the extension adapter means includes an cylindrical elongated extension adapter 158 having an annular internal threaded bore 160 that mates with and is selectively threaded onto the externally threaded portion 156 formed at the base end 56 of the handle 52 for adjusting the overall length of the tool 10. The extension adapter 158 also includes a cylindrical enlarged end portion 162 having a groove or channel 164 formed and extending transversely therethrough. The groove or channel 164 extends transverse to the longitudinal extension of the extension adapter 158 and is sized to fit onto the circular plate 16 as part of the process of securing the base end 56 of the tool 10 and the spring installation and removal member 62 to the washing machine 12 or 32.

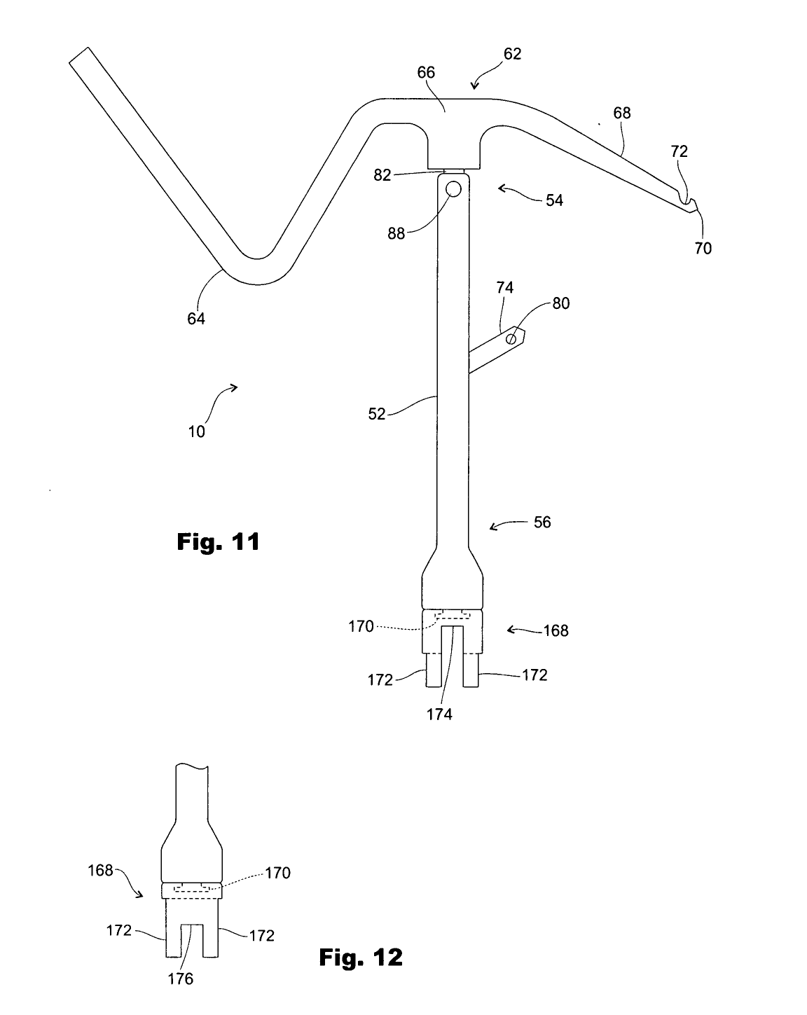

FIGS. 11 and 12 illustrate a fourth preferred embodiment for the extension adapter means of the present invention. An extension member 168 is rotatably mounted to the flat surface at the base end 56 of the handle 52. The extension member 168 is rotatably secured to the flat end surface by an internal rivet or brad 170. The extension member 168 also includes four legs 172 spaced from each other thereby forming two channels with the channels being at 90 degrees to each other. In addition, a first channel 174 has a depth that is greater than the depth of a second shallower channel 176. (The channel 174 shown in FIG. 11 in contrast to the channel 176 shown in FIG. 12.) Thus, the extension member 168 is rotated so that the appropriate channel 174 or 176 is aligned with the circular plate 16 so that the tool 10 has the right length for securement to structure on the washing machine 12 or 32 and the suspension spring(s) 26 or 42 by placing the desired channel 174 or 176 upon the edge of the circular plate 16.

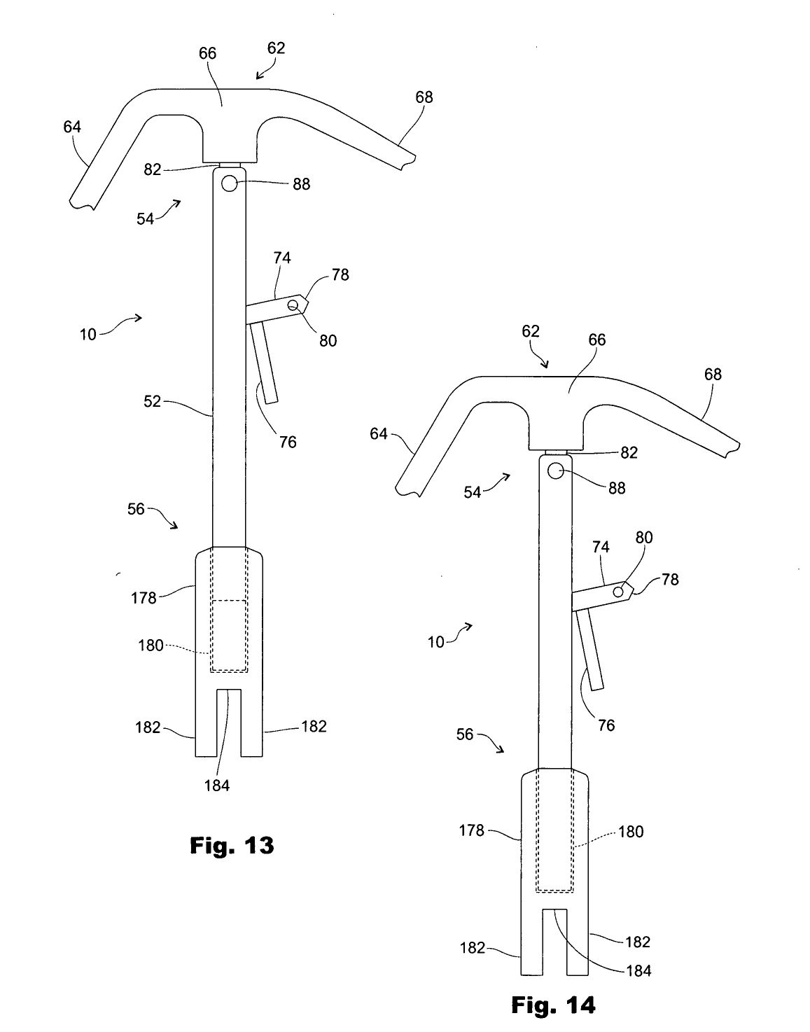

FIGS. 13 and 14 illustrate a fifth preferred embodiment for the extension adapter means for the tool 10 of the present invention. To accommodate the extension adapter means of FIGS. 13 and 14, the base end 56 of the handle 52 is cylindrical-shaped and of the same diameter as the body portion of the handle 52. Removably attachable to the base end 56 of the handle 52 is a cylindrical-shaped extension adapter 178. The extension adapter 178 includes a cylindrical internal bore 180 into which the base end 56 of the handle 52 is pressed or slid onto. The extension adapter 178 also includes a pair of legs 182 that define a channel 184 transverse to the longitudinal extension of the extension adapter 178 and the handle 52. Once the extension adapter 178 has been pressed onto the base end 56 of the handle 52, as shown in FIG. 14, the extension adapter 178 can be rotated for aligning the channel 184 with the circular plate 16 in order to facilitate the alignment of the channel 184—and the extension adapter 178—with the circular plate 16 and the securement of the tool 10 to the suspension spring (s) 26 or 42.

FIGS. 17 and 18 illustrate an alternative embodiment for the interconnection of the hand lever portion 64 and the spring arm 68. The hand lever portion 64 and the spring arm 68 are pivotally connected so that one or both elements can be pivoted and folded downward adjacent to the handle 52 when the tool 10 is not being used. When the tool 10 is to be used, the hand lever portion 64 and the spring arm 68 are pivoted upward and parallel to each other as shown in FIG. 17, and locked in place by the engagement of a tab 186 with a locking groove or slot 188.

In operation for installing or removing one or more suspension springs 26 from the top loading washing machine 12 the tool 10, and with reference to the preferred embodiment shown in FIGS. 1, 20, and 21, would be disposed at the bottom of the washing machine 12 with the recess 72 of the spring arm 68 brought into engagement with the upper end 28 of the suspension springs 26 and the slot 60 at the base end 56 mounted upon and over the edge of the circular plate 16. Pressing down on the hand lever portion 64 would cause the spring arm 68 to pivot upward thereby stretching the suspension spring 26 and lifting the suspension spring 26 up off the strut 18 to which the upper end 28 has been hooked about. The suspension spring 26 is then removable once the upper end 28 is detached and lifted up off the strut 18. Any of the alternative embodiments for extension adapter means, such as adjustable extension adapters 136, 148, 158, 168, and 178, can be used to allow the tool 10 to fit distances between the edge of the circular plate 16 and the point or height where the upper end 28 of the suspension spring 26 attaches to a structural support element such as the struts 18 at the bottom 20 of the top loading washing machine 12 of FIGS. 3 and 4. As shown in FIGS. 4 and 5, for removing the boot spring 42 from the front loading washing machine 32, the secondary spring arm 74 would be attached to one hook end 50 of the spring 42, and the recess 72 of the primary spring arm 68 would be engaged to the other hook end 50 of the boot spring 42 for removal of the boot spring 42 by pivoting the hand lever portion 64 and thus relieving the tension on the strap 46 so that the boot spring 42 can be detached from the strap 46 that circumscribes the tub 40 of the front loading machine 32.

A preferred embodiment of the invention, and a number of variations, have been disclosed herein, and it should be understood that numerous other modifications, alterations, and variations are possible and practicable to those skilled in the art while still remaining within the spirit and scope of the invention as set forth in the appended claims.

I claim:

1. A tool for the installation and removal of a spring mounted to an appliance, comprising:
a cylindrical elongated handle having an upper end and an opposite base end;
a pair of spaced-apart legs adjacent the base end and the legs defining a central stabilization slot in coaxial alignment with the handle;
a spring installation and removal member pivotally attached to the upper end of the handle;
the spring installation and removal member including a hand lever portion, an intermediate pivot portion, and a spring arm for engagement to the suspension spring with the hand lever portion and the spring arm being located in the same plane;
pivotal interconnection means for pivotally interconnecting the spring installation and removal member to the upper end of the handle; and
where upon the spring arm is attached to the spring and the base end of the handle is mounted to the appliance so that pivoting of the hand lever portion towards the handle rotates the spring arm and causes the disengagement of the spring in order to facilitate the removal and installation of the spring from the appliance.

2. The tool for the installation and removal of the spring of claim 1 further comprising an extension adapter means to vary and adjust the length of the tool so that the tool can be mounted to various designs and configurations of appliances.

3. The tool for the installation and removal of the spring of claim 2 further comprising a secondary spring arm mounted to the handle and laterally projecting therefrom.

4. The tool for the installation and removal of the spring of claim 3 wherein the pivotal interconnection means includes a pair of spaced-apart flanges located at the upper end of the handle with the flanges defining a pivot slot therebetween.

5. The tool for the installation and removal of the spring of claim 4 wherein the intermediate pivot portion includes a downwardly projecting member that is received within the pivot slot so that the spring installation and removal member can be pivotally mounted to the flanges at the upper end of the handle.

6. The tool for the installation and removal of the spring of claim 5 wherein the spring arm includes a recess for hooking onto the suspension spring prior to the installation and removal of the suspension spring.

7. A tool for the installation and removal of a suspension spring from a washing machine, comprising:
a cylindrical elongated handle having an upper end and an opposite base end;
a pair of spaced-apart legs adjacent the base end and the legs defining a central stabilization slot in coaxial alignment with the handle;
a spring installation and removal member pivotally attached to the upper end of the handle;
the spring installation and removal member including a hand lever portion, an intermediate pivot portion, and a spring arm with the spring arm capable of attachment to the suspension spring and the hand lever portion and the spring arm being located in the same plane;
pivotal interconnection means for pivotally interconnecting the spring installation and removal member to the upper end of the handle; and
whereupon attachment of the spring arm to the suspension spring and placement of the stabilization slot upon the circular plate of the washing machine allows the legs to extend adjacent the circular plate and attaches the base end to the circular plate so that pivoting of the hand lever portion toward the handle causes the spring arm to rotate and disengage the suspension spring to facilitate the installation and removal of the suspension spring.

8. The tool for the installation and removal of the suspension spring of claim 7 further comprising extension adapter means removably attachable to the base end of the handle for adjusting the length of the tool so that the tool can fit washing machines having different designs and configurations.

9. The tool for the installation and removal of the suspension spring of claim 8 further comprising a secondary spring arm mounted to the handle and laterally projecting therefrom.

10. The tool for the installation and removal of the suspension spring of claim 9 wherein the pivotal interconnection means includes a pair of spaced-apart ears extending from the upper end of the handle and coaxial with the handle.

11. The tool for the installation and removal of the suspension spring of claim 10 wherein the intermediate pivot portion is disposed between the spaced-apart ears for pivotally mounting the spring installation and removal member to the upper end of the handle.

12. The tool for the installation and removal of the suspension spring of claim 11 wherein the spring arm includes a recess for hooking the spring arm onto the suspension spring prior to the installation and removal of the suspension spring from the washing machine.

13. A tool for the installation and removal of a suspension spring from a washing machine, comprising:
a cylindrical elongated handle having an upper end and an opposite base end;
a pair of spaced-apart legs mounted to the base end and the legs defining a central stabilization slot in coaxial alignment with the handle;
a spring installation and removal member pivotally attached to the upper end of the handle;
the spring installation and removal member including a hand lever portion, an intermediate pivot portion, and a spring arm with the spring arm attachable to the suspension spring and the hand lever portion and the spring arm being located in the same plane;
the spring arm including a pointed tip and a recess located at the pointed tip for hooking onto the suspension spring;
pivotal interconnection means for pivotally interconnecting the spring installation and removal member to the upper end of the handle; and
whereupon attachment of the spring arm to the suspension spring and placement of the stabilization slot upon the circular plate of the washing machine allows the legs to extend adjacent to the circular plate for securing the base end to the circular plate so that the hand lever portion can be pivoted toward the handle thereby causing the spring arm to rotate and disengage the suspension spring thus allowing for the installation and removal of the suspension spring.

14. The tool for the installation and removal of the suspension spring of claim 13 further comprising extension adapter means removably attachable to the base end of the handle for adjusting the length of the tool so that the tool can fit different designs and configurations of washing machines.

15. The tool for the installation and removal of the suspension spring of claim 14 further comprising a secondary spring arm mounted to the handle and laterally projecting therefrom.

16. The tool for the installation and removal of the suspension spring of claim 15 further comprising a catch mounted to the handle adjacent the base end so that the hand lever portion can be pivoted and hooked onto the catch for holding the spring installation and removal member in the pivoted disposition.

17. The tool for the installation and removal of the suspension spring of claim 16 further comprising a right-angled elbow mounted to the handle adjacent the base end and laterally extending therefrom so that the hand lever portion can be pivoted and hooked onto the right-angled elbow for holding the spring installation and removal member in the pivoted disposition.

18. The tool for the installation and removal of the suspension spring of claim 17 wherein the hand lever portion is z-shaped to facilitate its manual gripping and pivotal motion.

19. A tool for the installation and removal of a spring, such as a suspension spring and a boot spring, that are mounted to an appliance, comprising:
a cylindrical elongated handle having an upper end and an opposite base end;
the base end including a plurality of fingers spaced from each other and forming gaps therebetween;
a spring installation and removal member pivotally attached to the upper end of the handle;
the spring installation and removal member including a hand lever portion, an intermediate pivot portion, and a spring arm for engagement to the spring with the hand lever portion and the spring arm being located in the same plane;
pivotal interconnection means for pivotally interconnecting the spring installation and removal member to the upper end of the handle; and
where upon the spring arm is attached to the spring and the fingers are disposed upon the circular plate or housing suspension of the appliance so that pivoting of the hand lever portion towards the handle rotates the spring arm and causes the disengagement of the spring in order to facilitate the removal and installation of the spring from the appliance.

20. The tool for the installation and removal of the spring of claim 19 wherein the base end includes at least three fingers defining two gaps for placement on the circular plate or housing suspension of the appliance.
